(19) United States
(12) Patent Application Publication
(10) Pub. No.: US 2026/0159179 A1
(43) Pub. Date: Jun. 11, 2026

(54) DEVICE FOR ASSEMBLING A SIDE MEMBER AND A CHASSIS CROSS MEMBER OF A MOTOR VEHICLE, ASSEMBLY AND VEHICLE COMPRISING SUCH A DEVICE

(71) Applicant: FLEXIS, BOULOGNE-BILLANCOURT (FR)

(72) Inventors: Frederic BAIA, VELIZY-VILLACOUBLAY (FR); David FERREIRA, VILLIERS-SAINT-FREDERIC (FR)

(21) Appl. No.: 19/414,893

(22) Filed: Dec. 10, 2025

(30) Foreign Application Priority Data
Dec. 10, 2024 (FR) FR2413778

(51) Int. Cl. B62D 27/02; B60S 11/00; B62D 21/11

(52) U.S. Cl. CPC B62D 27/023; B60S 11/00; B62D 21/11

(57) ABSTRACT

An assembly device of a side member and a chassis cross member of a motor vehicle. The assembly device is formed of a single rigid metal piece, characterized in that the assembly device presents an assembly surface portion in contact with each other, by welding, of the assembly device and an anchoring element of the rear axle of the motor vehicle to the chassis of this motor vehicle.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The disclosure relates to the automotive field, in particular the technical field dealing with the attachment of the rear axle of a motor vehicle to the chassis of this motor vehicle, when the motor vehicle is an electric or hybrid vehicle equipped with electric batteries or a fuel cell associated with at least one fuel tank, notably hydrogen.

The anchoring zone of the ground connection elements of a motor vehicle to the body of this vehicle constitutes an entry point for the forces coming from the wheels on the body. These forces are significant when the vehicle is loaded and/or driving on degraded roads and/or at high speed. To ensure acceptable structural integrity of the body under the effect of these forces, the external (point A) and internal (point B) attachment points of the rear axle of this motor vehicle must be reinforced.

In particular, for an electric or hybrid propulsion vehicle, the propulsion of which is ensured by at least one electric motor drawing its energy from at least one electric battery, the size of these electric batteries requires optimization of the position of the internal and external attachment points of the rear axle of this motor vehicle. The same applies to an electric propulsion vehicle equipped with a fuel cell using hydrogen as fuel stored in at least one tank, which is also bulky.

### BACKGROUND

A utility motor vehicle is known in which a chassis presents a gusset for assembling a side member and a cross member of the chassis. Such a utility motor vehicle also presents a point A for attaching the rear axle of this utility motor vehicle, comprising a clevis formed of two flanges connected to each other by a sheet metal piece fixed to the side member. The clevis is not attached to the cross member. The rigidity of the assembly formed by the gusset, the cross member, the side member, and the clevis for attaching the rear axle is therefore not optimized.

Other electric motor vehicles are known in which the clevis of point A for attaching the rear axle of this motor vehicle is reported to be screwed under the body of these motor vehicles. As a result, the clevis of point A does not contribute in an optimal way to the structural integrity of the chassis.

A hybrid motor vehicle is known in which the clevis of point A for attaching the rear axle of this hybrid motor vehicle is reported to be screwed under the body of this hybrid motor vehicle. As a result, the clevis of point A does not significantly contribute to the structural integrity of the chassis.

An electric motor vehicle is also known in which the clevis of point A for attaching the rear axle of this electric motor vehicle is reported to be welded under the body of this hybrid motor vehicle. As a result, the clevis of point A does not significantly contribute to the structural integrity of the chassis. the disclosure aims to overcome these disadvantages.

The disclosure therefore aims to propose a device for assembling a side member and a cross member of a motor vehicle chassis, notably an electric or hybrid motor vehicle, also allowing reinforcement of the clevis of point A.

In particular, the disclosure aims to propose an assembly device also allowing reinforcement of the connection between a cross member and a side member of the chassis of a motor vehicle and a gusset of this motor vehicle.

But the disclosure also aims to propose such a compact assembly device allowing, due to this compact footprint, to provide and/or increase a space for receiving electric batteries powering the motor of an electric or hybrid vehicle.

But the disclosure also aims alternatively to propose such a compact assembly device allowing, due to this compact footprint, to provide and/or increase a space for receiving hydrogen tanks powering a fuel cell for the motor of an electric vehicle.

The disclosure also aims to propose a compact assembly comprising such an assembly device allowing to structurally reinforce the chassis of the motor vehicle and/or allowing, due to this compact footprint, to provide and/or increase a space for receiving electric batteries powering the motor of an electric or hybrid vehicle or hydrogen tanks powering a fuel cell for the motor of an electric vehicle.

The disclosure also aims to propose a motor vehicle, notably an electric or hybrid vehicle, allowing an increase in the length of a reception volume and the installation of electric batteries or hydrogen tanks powering a fuel cell.

### SUMMARY

The disclosure therefore has as its object an assembly device or “gusset”—of a side member and a chassis cross member of a motor vehicle, said assembly device being formed of a single rigid metal piece, characterized in that the assembly device presents an assembly surface portion in contact with each other by welding, of the assembly device and an anchoring element of a rear axle of the motor vehicle to the chassis of this motor vehicle.

Throughout the text:
the terms “front”, “rear”, “right”, “left”, “top”, “bottom”, and “side” are to be considered relative to a vehicle in a normal state of progress,
the XYZ reference refers to a direct orthonormal reference XYZ conventionally used in automotive design, in which the X-axis designates the longitudinal front-rear direction of the vehicle, oriented toward the rear, the Y-axis designates the transverse direction and is oriented laterally from the left toward the right of the vehicle, the Z-axis designates the vertical direction, and is oriented from the bottom toward the top. Such a direct orthonormal reference XYZ according to standard No.0100112 is schematically represented in FIG. 6.

In the automotive field, the side members and cross members forming the chassis are constitutive elements of the rigidity of the vehicle structure. The elongation axis of the side members extends generally according to the X-axis of the direct orthonormal reference XYZ conventionally used in automotive design and the elongation axis of the cross members extends generally according to the Y-axis of this same direct orthonormal reference XYZ, side members and cross members extending substantially in the same plane orthogonal to the Z-axis of this same direct orthonormal reference XYZ.

According to the disclosure, the assembly device is a multifunctional assembly device allowing to realize a rigid and compact assembly, by welding, of a side member and a chassis cross member and at least one rear axle anchoring element of the motor vehicle. Such an assembly device, by welding, allows to reinforce the rigidity of the vehicle structure and allows to ensure the integrity of this structure subjected to forces coming from the wheels and transmitted to the body by the ground connection elements. But such a compact assembly device also provides a compact rear axle anchoring, with rear axle anchoring points not extending, toward the front, beyond the cross member and in such a way as to free up space extending in front of the cross member and allocated to electric batteries or hydrogen tanks powering a fuel cell for this electric vehicle.

According to the disclosure, the assembly device presents a generally concave main face delimiting the reception volumes of the side member and the cross member. This concave main face is an upper face according to the Z-axis of the direct orthonormal reference when the assembly device is in the assembled state on the motor vehicle. According to the disclosure, the assembly device presents a generally convex main face, opposite to the concave main face, forming a lower face according to the Z-axis of the direct orthonormal reference when the assembly device is in the assembled state on the motor vehicle.

According to certain embodiments, the welded assembly surface portion, in contact with each other, by welding, of the assembly device and the anchoring element of the rear axle is a surface portion of the concave main face of the assembly device. According to certain other embodiments, the assembly surface portion in contact with each other, by welding, of the assembly device and the anchoring element of the rear axle is a surface portion of the convex main face of the assembly device.

According to the disclosure, the assembly device is shaped so as to be fixed by welding, notably to be fixed by welding, with the anchoring element of the rear axle of the motor vehicle to the chassis of this motor vehicle. The assembly device according to the disclosure constitutes a “structural node” allowing a transfer of forces coming from the motor vehicle ground connection elements, at least to the side member and the chassis cross member and to the motor vehicle body. These forces are all the more important when the vehicle is loaded or when the vehicle is an electric or hybrid vehicle with increased mass due to electric batteries and/or hydrogen tanks powering a fuel cell. These forces are all the more important when the vehicle is driving at high speed and/or on a road the surface of which is degraded

According to certain embodiments, the assembly device is formed by stamping a sheet of metal. Any other means of obtaining such a rigid metallic piece is, however, possible. According to certain embodiments, the assembly device is formed of steel. According to these embodiments, the assembly device is formed of a rigid metal piece of substantially constant thickness.

According to certain embodiments, the assembly device according to the disclosure forms a clearance, said longitudinal clearance, able to receive the said side member, to be able to cooperate by shape cooperation with the said side member and to be able to secure the assembly device and the said side member by welding the assembly device and the said side member to each other.

The said longitudinal clearance extends longitudinally, according to an axis substantially parallel to the X-axis of the direct orthonormal reference XYZ (conventionally used in automotive design) and schematically represented in FIG. 6, when the assembly device is arranged in such a way as to cooperate with the said side member, with the cross member and at least with the anchoring element of the rear axle of the motor vehicle.

According to certain embodiments, the said longitudinal clearance of the assembly device is shaped to cooperate with, notably to be able to be welded to, two free adjacent main faces of the said side member with which the assembly device is intended to cooperate. According to these embodiments, the two free adjacent main faces of the said side member are an internal main face of the said side member and a lower main face of the said side member according to the direct orthonormal reference XYZ.

According to certain embodiments, the said longitudinal clearance of the assembly device presents an edge, so-called edge of side member, intended to cooperate by contact with the side member, the said edge of side member formed by folding, at least a first substantially flat extension arranged to be able to be welded to a first face of the two free adjacent faces of the side member with which the assembly device is intended to cooperate. According to these embodiments, the first face of the two free adjacent faces of the side member is an internal main face of the side member. According to these embodiments, the first face of the two free adjacent faces of the side member is a main face of the said side member substantially orthogonal to the Y-axis of the direct orthonormal reference. By surface substantially orthogonal to the Y-axis of the direct orthonormal reference, is meant a surface the normal of which forms with the Y-axis an angle of less than 10° given the trapezoidal cross-sectional shape of the said side member.

According to certain embodiments, the said edge of side member forms at least a second substantially flat extension arranged to cooperate with a second face, distinct from the first face, of the two free adjacent main faces of the side member with which the assembly device is intended to cooperate. According to these embodiments, the second face of the two free adjacent faces of the side member is a lower main face of the side member. According to these embodiments, the second face of the two free adjacent faces of the side member is a main face of the side member, extending in a plane substantially orthogonal to the Z-axis of the direct orthonormal reference. By plane substantially orthogonal to the Z-axis of the direct orthonormal reference, is meant a surface the normal of which forms with the Z-axis an angle of less than 10°.

According to certain embodiments, the said longitudinal clearance of the assembly device presents an edge, said edge of side member, intended to be in contact with the said side member and provided with substantially flat extensions of which:
at least one first extension, notably a pair of first extensions opposite to each other, the said at least first extension, notably the pair of first extensions, being able to cooperate with a first face of the two free adjacent main faces of the side member with which the assembly device is intended to cooperate, and
at least one second extension, notably a pair of first extensions opposite to each other, the said at least second extension, notably the pair of second extensions, being able to cooperate with a second face of the two free adjacent main faces of the side member with which the assembly device is intended to cooperate. According to certain embodiments, the first face of the two free adjacent faces of the side member is an internal main face of the said side member. According to certain embodiments, the second face of the two free adjacent faces of the side member is a lower main face (orthogonal to the Z-axis of the direct orthonormal reference) of the said side member.

According to certain embodiments, the said at least one first extension and the said at least one second extension cooperate with the first and second free adjacent main faces of the side member by a portion of the concave main face of the assembly device. Nothing prevents, however, from providing, according to other embodiments, that the said at least first extension and the said at least second extension cooperate with the first and second free adjacent main faces of the side member by a portion of the convex main face of the assembly device.

The said side member edge of the said longitudinal clearance delimits from front to rear (according to the X-axis of the direct orthonormal reference) a reception volume of the side member. The reception volume of the side member presents a height extending according to the Z-axis of the direct orthonormal reference able to cooperate with a side member of substantially the same height according to the Z-axis of the direct orthonormal reference.

According to certain embodiments, the said longitudinal clearance is shaped to be able to receive the side member and be traversed by the said side member according to the X-axis of the direct orthonormal reference.

According to certain embodiments, the said longitudinal clearance of the assembly device presents a portion of edge (which is not intended to be in contact with the said side member), said anchoring edge, intended to be in contact with the rear axle anchoring element of the motor vehicle and to fix by welding the assembly device and the anchoring element of the rear axle of the motor vehicle. According to certain embodiments, the said rear axle anchoring edge extends in a plane substantially orthogonal to the Y-axis of the direct orthonormal reference and in such a way that the said rear axle anchoring edge does not extend facing the side member. By plane substantially orthogonal to the Y-axis of the direct orthonormal reference, is meant a plane the normal of which forms with the Y-axis an angle of less than 10°.

According to certain embodiments, the assembly device according to the disclosure forms a groove, called transverse groove, adapted so as to be able to receive the cross member, to cooperate in shape cooperation with the cross member and to be able to secure the assembly device with the cross member by welding the assembly device and the cross member to each other. The said transverse groove determines a reception volume of the cross member. The said transverse groove of the assembly device presents an elongation axis substantially parallel to the Y-axis of the direct orthonormal reference when the assembly device is in the assembly position in the motor vehicle.

According to the disclosure, the said transverse groove and the said longitudinal clearance of the assembly device form a “T” extending in a plane orthogonal to the Z-axis of the direct orthonormal reference. The said transverse groove and the said longitudinal clearance present reception axes of the cross member and respectively of the side member orthogonal to each other. According to certain embodiments, the reception axes of the cross member and respectively of the side member extend in two distinct parallel planes substantially orthogonal to the Z-axis of the direct orthonormal reference. According to certain embodiments, the reception axes of the cross member and respectively of the side member extend in the same plane substantially orthogonal to the Z-axis of the direct orthonormal reference.

According to certain embodiments, the said transverse groove is shaped to cooperate with three free adjacent main faces of the cross member with which the assembly device is intended to cooperate and to be able to be welded to the cross member. According to these embodiments, the three free adjacent main faces of the said cross member are a front main face (−X) of the said cross member, a rear main face (+X) of the said cross member, and a lower main face (−Z) of the said cross member according to the direct orthonormal reference XYZ.

According to certain embodiments, the said transverse groove presents an edge, said cross member edge, delimiting toward the top (+Z) the reception volume of the cross member. The said cross member edge presents a front extension (according to the −X axis) substantially flat, extending horizontally and in a plane substantially orthogonal to the Z-axis of the direct orthonormal reference and arranged to be able to cooperate and be welded with a front edge of the cross member. The said cross member edge has a rear extension (according to the +X axis) substantially flat, extending horizontally and in a plane substantially orthogonal to the Z-axis of the direct orthonormal reference and arranged to be able to cooperate with and be welded to a rear edge of the cross member.

According to certain embodiments, the said transverse groove presents, according to its elongation axis substantially parallel to the Y-axis of the direct orthonormal reference, a first terminal end section of cylindrical shape and presenting front and rear extensions arranged to cooperate with the edges of the cross member. In certain embodiments, the said transverse groove presents, according to its elongation axis substantially parallel to the Y-axis of the direct orthonormal reference, a second section extending the first section, flared from the first section and presenting front and rear extensions arranged to be able to be welded with an edge of the side member. According to these embodiments, the second section is flared from the first section toward the front and toward the rear according to the X-axis and toward the bottom according to the Z-axis. The rigidity of the assembly device and the structure of the motor vehicle is reinforced.

According to certain embodiments, at least one extension of the said edge of cross member is intended to be in contact with the cross member and to be welded to the cross member by a portion of the concave main face of the assembly device.

The said cross member edge of the said transverse groove delimits a reception volume of the cross member. The reception volume of the cross member presents a height extending according to the Z-axis of the direct orthonormal reference able to cooperate with a cross member of substantially the same height according to the Z-axis of the direct orthonormal reference. According to certain embodiments, the height of the cross member being less than the height of the side member, the height of the reception volume of the cross member is less than the height of the reception volume of the side member. The reception volume of the cross member presents a width extending, according to the X-axis of the direct orthonormal reference able to cooperate with a cross member of substantially the same width, according to the X-axis of the direct orthonormal reference.

According to certain embodiments, the said transverse groove is shaped to be able to receive a longitudinal end of the cross member, the longitudinal end of the cross member being substantially in abutment with the side member according to the Y-axis of the direct orthonormal reference.

According to certain embodiments, the assembly device presents a surface for secure welding of the assembly device to a rear support member for a vehicle lifting jack. The rigidity of the motor vehicle structure is reinforced and the compact footprint of the assembly device and the anchoring element of the rear axle to the chassis is preserved.

According to certain embodiments, the surface for secure welding of the assembly device to the rear support member for a lifting jack is substantially flat and extends over a portion of the convex main face of the assembly device, opposite to the concave main face of the assembly device, the part of the assembly device presenting this convex main face portion limiting the reception volume of the side member. According to certain embodiments, the surface for secure welding extends substantially in a plane orthogonal to the Z-axis of the direct orthonormal reference and is substantially horizontal.

Advantageously, the surface portion of the device according to the disclosure, for welding the assembly with the anchoring element of the rear axle of the motor vehicle, to the chassis of this motor vehicle is distinct from the assembly surface portions of the device according to the disclosure respectively with the side member and the cross member. The surface portion, said rear axle anchoring surface, of the assembly device intended to be welded to the anchoring element of the rear axle extends in a plane, said rear axle anchoring plane, substantially orthogonal to the Y-axis of the direct orthonormal reference, at one of the terminal ends of the assembly device (according to this Y-axis) opposite to the terminal end of reception of the cross member. The said rear axle anchoring surface is formed of at least one extension extending by folding in the said anchoring plane from the said anchoring edge. According to certain embodiments, each extension forming the said rear axle anchoring surface extends in a plane orthogonal to the secure surface of the assembly device with the rear support member for a lifting jack. The rigidity of the assembly device and the structure of the motor vehicle is reinforced and the compact footprint of the assembly device and the rear axle anchoring element to the chassis is preserved.

In a motor vehicle comprising an assembly device according to the disclosure, each extension forming the said rear axle anchoring surface is fixed by welding to the anchoring element. In certain embodiments, the anchoring element of the rear axle of the motor vehicle is also fixed by welding to a third free main face of the side member.

According to certain embodiments, the anchoring element of the rear axle to the chassis of the motor vehicle is a housing supporting a bearing of point A of the vehicle, cooperating with a cylindrical articulation ring of the rear axle suspension arm end of the motor vehicle.

According to certain embodiments, the anchoring element comprises an internal fin (according to the Y-axis of the direct orthonormal reference) assembled by welding to the assembly device and an external reinforcement (according to the Y-axis of the direct orthonormal reference), the internal fin and the external reinforcement of the anchoring element being able to receive and maintain an end bearing for fixing a rear axle suspension arm to the chassis of the motor vehicle, the support member and the external reinforcement being securely mounted with each other by welding. According to certain embodiments, the support member and the internal fin are securely mounted with each other by welding. According to certain embodiments, the internal fin and the external reinforcement of the anchoring element constitute an anchoring interface of a suspension control arm. The internal fin and the external reinforcement provide between them a gap distance, the value of which is able to receive the suspension arm end and support a shaft able to cooperate with the suspension arm bearing.

According to certain embodiments, the support member is securely mounted by welding with at least one member chosen from among a gusset and a spar of this motor vehicle. According to these embodiments, the assembly device allows structural continuity between:
longitudinal structural elements such as the side member and the gusset,
transverse structural elements such as the cross member, and
vertical structural elements such as the spar forming a structural node.

The disclosure also extends to an assembly comprising an assembly device according to the disclosure, characterized in that it further comprises:
an anchoring element of the rear axle of this motor vehicle to the chassis of the motor vehicle, the anchoring element being securely mounted to the assembly device by welding;
a rear support member for a lifting jack for the motor vehicle, the support member being securely mounted to the assembly device by welding.

According to certain embodiments, at least one of the assembly device, the anchoring element of the rear axle, and the rear support member is formed of steel. According to certain embodiments, each of the assembly device, the anchoring element of the rear axle and the rear support member are formed of steel. The assembly according to the disclosure is a high mechanical strength assembly. The assembly according to the disclosure allows to form an effective, rigid, and compact connection between the cross member, the support member, and the gusset but also to reinforce the connection of this assembly with the anchoring element of the rear axle in a compact connection allowing to limit its footprint and to provide space for the installation of an electric battery or fuel tank(s), notably hydrogen, for a fuel cell.

The disclosure also extends to a motor vehicle comprising at least one assembly device according to the disclosure or at least one assembly according to the disclosure.

According to certain embodiments, the motor vehicle is an electric or hybrid vehicle.

According to certain embodiments, the motor vehicle is an electric vehicle equipped with electric batteries or a fuel cell powered by at least one hydrogen tank.

According to certain embodiments, the motor vehicle is a utility vehicle. According to certain embodiments, the motor vehicle is a vehicle in which the powertrain is located at the front. Nothing prevents, however, from providing that the motor vehicle is a vehicle in which the powertrain is located at the rear.

According to certain embodiments, the motor vehicle is a rear-wheel drive vehicle.

According to certain embodiments, the motor vehicle is a front-wheel drive vehicle.

According to certain embodiments, the motor vehicle is an all-wheel drive vehicle.

### BRIEF DESCRIPTION OF THE DRAWINGS

Other features and advantages will become apparent on reading the following description. This is purely illustrative and should be read in relation to the attached drawings in which:

FIG. 1 is a perspective view of the convex main face of an assembly device according to an embodiment,

FIG. 2 is a perspective view of the concave main face of an assembly device according to the embodiment,

FIG. 3 is a transverse cross-sectional representation (according to a plane orthogonal to the X-axis of the direct orthonormal reference of FIG. 6) and a rear view of a detail of a vehicle, an assembly, and an assembly device according to the embodiment,

FIG. 4 is a flat bottom view of a detail of a motor vehicle according to the embodiment, in which the ground connection elements of the motor vehicle are not represented,

FIG. 5 is a view in perspective bottom and of below of a detail of a motor vehicle according to the embodiment, in which the ground connection elements of the motor vehicle are not represented, and

FIG. 6 is a representation of a direct orthonormal reference XYZ conventionally used in automotive design.

### DETAILED DESCRIPTION

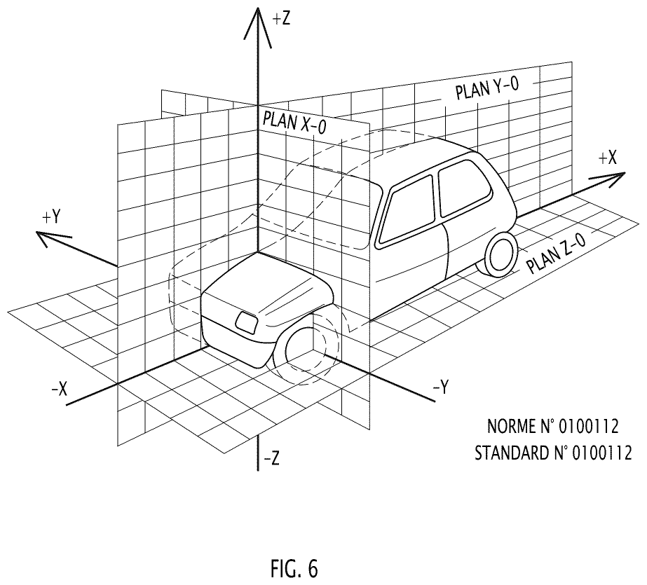

For the purposes of the description, reference will be made to a direct orthonormal reference XYZ according to standard No.0100112 represented in FIG. 6, in which the X-axis designates the longitudinal front-rear direction of the vehicle and is oriented toward the rear, the Y-axis designates the transverse direction and is oriented toward the right of the vehicle, the Z-axis designates the vertical direction and is oriented toward the top.

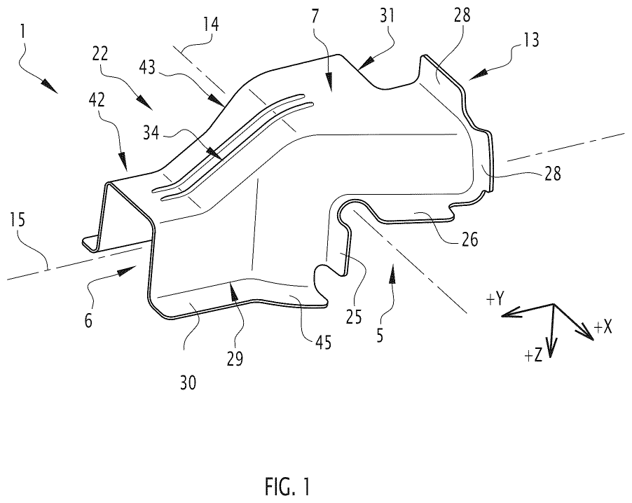

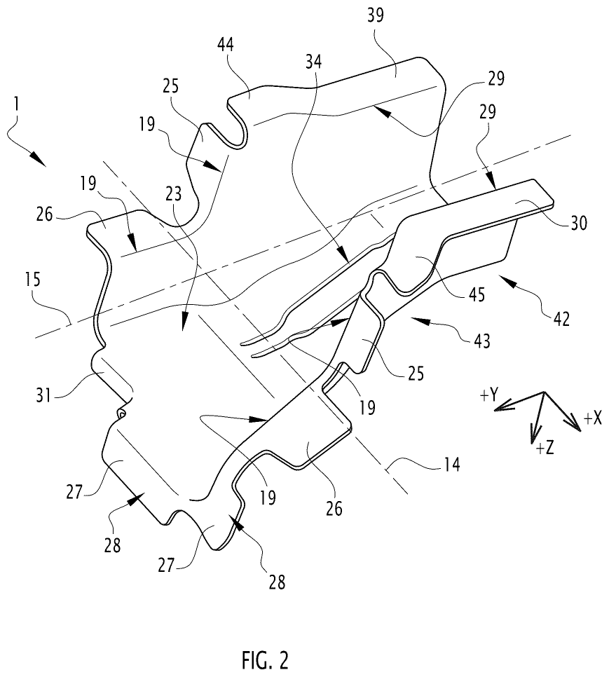

The assembly device 1 or gusset, represented in perspective in FIG. 1 by its convex face 22 and in FIG. 2 by its concave face 23, is formed of a single piece of stamped steel sheet. The assembly device 1 formed by stamping a sheet metal plate presents a folded shape chosen to confer the required bending rigidity. Indeed, the assembly device 1 according to the disclosure is intended to allow a rigid assembly of the chassis elements and the rear axle of a motor vehicle, these chassis and rear axle elements being highly mechanically stressed due to their connection with the wheels of the motor vehicle in displacement. The folds imparted to the stamped steel sheet of the assembly device 1 according to the disclosure, notably, but not exclusively the folds established between two orthogonal or substantially orthogonal wall portions, constitute bending rigidity reinforcements of the assembly device 1 according to the three axes XYZ of the direct orthonormal reference. Furthermore, the assembly device 1 according to the disclosure is formed of a single compact piece allowing to group in an optimized and minimal volume, the assembly means of a side member 2, a cross member 3, and at least one rear axle anchoring element 4 of the motor vehicle. This optimized volume allows to provide an increased space for receiving electric battery element(s) and/or fuel tank(s) powering a fuel cell.

The assembly device 1 forms a groove, said transverse groove 6, able to receive a cross member (not represented in FIGS. 1 and 2), to cooperate in shape together with the cross member and to be able to secure the assembly device 1 with the cross member by welding the assembly device 1 and the cross member 3 to each other. The said transverse groove 6 extends according to an elongation axis identified in FIGS. 1 and 2 by reference 15. The said transverse groove 6 presents a first free terminal end section 42 of the said transverse groove 6 and of transverse cross-section (orthogonal to the elongation axis 15 of the said transverse groove, the elongation axis 15 being parallel to the Y-axis of the direct orthonormal reference) of substantially rectangular shape. The dimensions of the first section 42 of the said transverse groove 6 are adjusted to the dimensions of the cross member. The first section 42 of the said transverse groove 6 presents an edge, said edge 29 of the cross member, delimiting toward the top (+Z) a reception volume of the cross member. The said edge 29 of the cross member presents a front extension 30 (according to the −X axis) substantially flat, extending horizontally and in a plane substantially orthogonal to the Z-axis of the direct orthonormal reference and arranged to be able to be welded with a front edge 40 of the cross member. The said edge 29 of the cross member presents a rear extension 39 (according to the +X axis) substantially flat, extending horizontally and in a plane substantially orthogonal to the Z-axis of the direct orthonormal reference and arranged to be able to be welded with a rear edge 41 of the cross member.

The said transverse groove 6 presents a second flared section 43, extending toward the exterior (+Y) the first section 42 according to the axis 15 of the said transverse groove 6 and reception of the cross member 3. The second flared section 43 is flared toward the front and toward the rear according to the X-axis and toward the bottom according to the Z-axis. The rigidity of the assembly device 1 and the structure of the motor vehicle is thus reinforced. The second flared section 43 presents front 44 and rear 45 extensions arranged to be able to be welded each with an edge 46 of the side member. The folds formed between the first section 42 and the second flared section 43 of the assembly device 1 and by the front and rear extensions 30,39 contribute to the reinforcement of the rigidity of the assembly device 1 according to the disclosure, according to the three axes XYZ of the direct orthonormal reference.

The assembly device 1 also forms a clearance, said longitudinal clearance 5, able to receive the said side member (not represented in FIGS. 1 and 2), to be able to cooperate by shape together with a side member and to be able to secure the assembly device 1 and the side member by welding the assembly device and the side member to each other. The said longitudinal clearance 5 extends according to an elongation axis identified in FIGS. 1 and 2 by reference 14. The said longitudinal clearance 5 is shaped to be able to be welded to two free adjacent main faces of the side member with which the assembly device is intended to cooperate. According to these embodiments, the two free adjacent main faces of the said side member are an internal main face of the said

side member and a lower main face of the said side member according to the direct orthonormal reference XYZ. The said longitudinal clearance of the assembly device 1 represented in FIGS. 1 and 2 presents an edge, said edge 19 side member, intended to cooperate by contact with the side member, the said edge 19 side member forming by folding, at least one first substantially flat extension 25 arranged to be able to be welded to a first face of the two free adjacent faces of the side member with which the assembly device 1 is intended to cooperate.

According to these embodiments, the first face of the two free adjacent faces of the side member is an internal main face of the side member. According to these embodiments, the first face of the two free adjacent faces of the side member is a main face of the said side member, substantially orthogonal to the Y-axis of the direct orthonormal reference. The said edge 19 side member forms at least a second substantially flat extension 26 arranged to cooperate with a second face, distinct from the first face, of the two free adjacent main faces of the side member with which the assembly device 1 is intended to cooperate. According to these embodiments, the second face of the two free adjacent faces of the side member is a lower main face of the side member. According to these embodiments, the second face of the two free adjacent faces of the side member is a main face of the side member, extending in a plane substantially orthogonal to the Z-axis of the direct orthonormal reference.

The assembly device 1, according to the disclosure presents a stiffening fold 34 oriented in a plane orthogonal to the X-axis chosen to allow reinforcement of the bending rigidity, notably according to the elongation axis 15 of the said transverse groove 6.

The assembly device 1 also presents a welded assembly surface portion 13, in contact one to the other, by welding, of the assembly device 1 and an anchoring element 4 of the rear axle of the motor vehicle 20 to the chassis 21 of this motor vehicle 20. This portion 13 of the assembly surface by welding of the assembly device 1 and the anchoring element 4 of the rear axle 18 extends in a plane orthogonal to the elongation axis 15 of

the said transverse groove 6 and at the other terminal ends of the assembly device 1, opposite to the free end 42 of the said transverse groove 6. The portion 13 of the assembly surface by welding the assembly device 1 and the anchoring element 4 is formed by a plurality of extensions 28 extending from an edge, said rear axle anchoring edge 27, of the said longitudinal clearance 5, the said rear axle anchoring edge 27 not being intended to be in contact and be fixed to the side member 2. The rear axle anchoring extensions 28 extend in a plane substantially orthogonal to the elongation axis 15 of the said transverse groove 6 and contribute, due to the folds of the said rear axle anchoring edge 27, to the rigidity of the assembly device 1.

The assembly device 1 also presents a securing surface 7 by welding of the assembly device 1 to a rear support member 8 for a motor vehicle 20 lifting jack. The securing surface 7 of the assembly device 1 and the support member 8 is substantially flat and extends over a portion of the convex main face 22 of the assembly device 1, opposite to the concave main face 23 of the assembly device 1. The securing surface 7 extends substantially in a plane orthogonal to the Z-axis of the direct orthonormal reference and is substantially horizontal. The said rear axle anchoring edge 27 of the securing surface 7 also presents at least one dropped edge 31 contributing, abundantly due to these folds, to the bending rigidity of the assembly device 1. The rigidity of the assembly device 1 and the structure of the motor vehicle 20 is reinforced and the compact footprint of the assembly device 1 and the anchoring element 4 of the rear axle 18 to the chassis 21 is preserved.

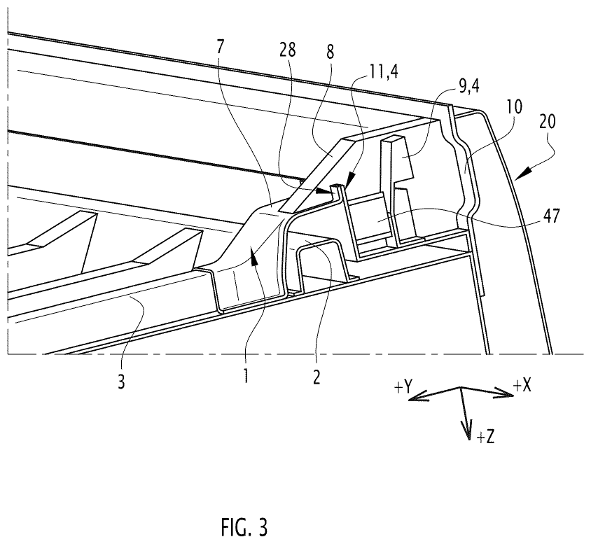

An assembly 12 according to the disclosure comprising an assembly device 1 is represented in FIG. 3 in transverse section according to a plane orthogonal to the X-axis of the direct orthonormal reference. The assembly 12 comprises the assembly device 1 fixed to the cross member 3 and the side member 2, a rear support member 8 for a motor vehicle 20 lifting jack, the support member 8 being securely mounted with the assembly device 1 by welding onto the securing surface 7 of the assembly device 1. The support member 8 is also fixed by welding to a gusset 10 of the motor vehicle 20. The assembly 12 also comprises an anchoring element 4 of a rear axle 18 of the motor vehicle 20 to the chassis 2,3 of the motor vehicle 20. The anchoring element 4 of the rear axle is formed of an internal fin 11 and an external reinforcement 9 supporting a shaft 47 able to cooperate with a suspension arm bearing 32. In the represented embodiment, the internal fin 11 is fixed by welding to an extension 28 of the said rear axle anchoring edge 27 of the assembly device 1. Nothing prevents providing that the internal fin 11 is also fixed by welding to one of the main faces of the side member 2. In the represented embodiment, the external reinforcement 9 is fixed by welding to the rear support member 8 for a lifting jack. According to a particular embodiment, the welded assemblies are spot welded assemblies. The rigidity of the assembly 12 according to the disclosure and its compact footprint allows to optimize the available space for electric batteries and/or hydrogen tanks powering a fuel cell of an electric vehicle 20. In addition, it should be noted that the assembly device 1 integrated into the assembly 12 comprising the assembly device 1 allows, due to the substantially flat securing surface 7, the motor vehicle 20 being assembled on an assembly line to be supported by a conveyor sled.

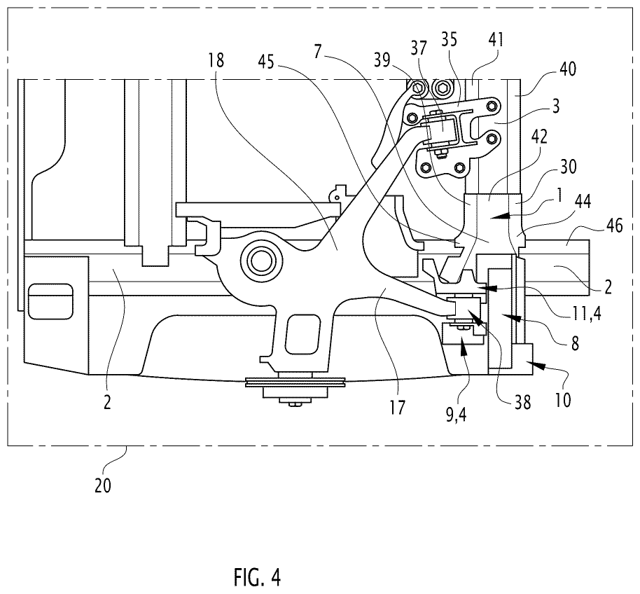

A detail of an assembly 12 of a motor vehicle 20 according to the disclosure is represented in a flat view from below in FIG. 4. The motor vehicle 20 presents a side member 2 extending according to the X-axis of the direct orthonormal reference and a cross member 3 extending according to the Y-axis of the direct orthonormal reference. The side member 2 and the cross member 3 constitute structural elements of the chassis 21 of the motor vehicle 20. As can be observed in FIG. 4 (on the right of FIG. 4), a free space is provided in front of the rear axle 18 of the electric vehicle 20 in order to be able to receive the electric batteries 24. The rear axle 18 of the electric vehicle 20 represented in FIG. 4 comprises a first suspension arm 17 ending toward the front with a cylindrical articulation ring 38 comprising an articulation bearing allowing a pivot connection between the end 38 of the suspension arm 17 and a first element, said point A, for attaching the rear axle 18 to the chassis 21. A second arm of the suspension wishbone ends toward the front with a cylindrical articulation ring 37 comprising an articulation bearing allowing a pivot connection between the end 37 of the second suspension arm and a second element 35, said point B, for complementary attachment of the rear axle 18 to the chassis 2,3,21. The end of the suspension arm 17 forms a hollow cylinder for receiving a bearing cooperating with a shaft 47 supported by the internal fin 11 and the external reinforcement 9 of the anchoring element 4 of the rear axle 18 of the motor vehicle 20 to the chassis 2,3,21 of this electric vehicle. The assembly device 1, the side member 2, the cross member 3, the internal fin 11 of the anchoring element 4 of the rear axle 18 of the electric vehicle 20 to the chassis 2,3,21 of this electric vehicle, the external reinforcement 9 of this anchoring element 4 of the rear axle 18 of the electric vehicle 20, the rear support member 8 for a lifting jack, and the gusset 10, these elements being connected by welding together, provide a rigid and compact anchoring of the rear axle 18 of an electric vehicle 20 to the chassis 21 of this electric vehicle 20.

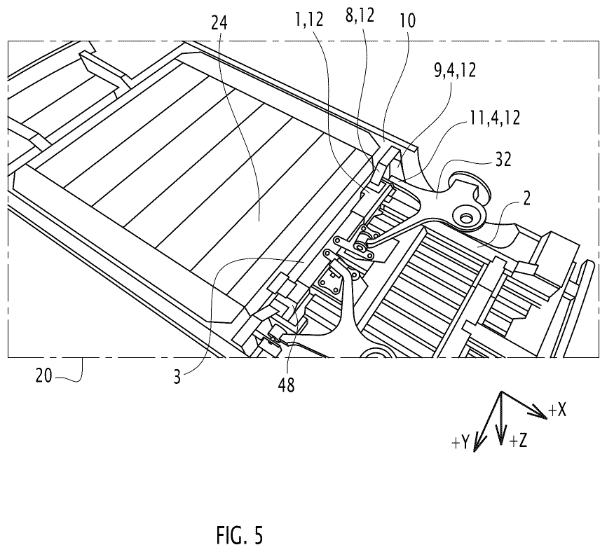

The assembly 12, according to the disclosure comprises the assembly device 1. It also comprises an internal fin 11 and an external reinforcement 9 forming an anchoring element 4 of the rear axle 18 to the chassis 2,3,21 of the electric vehicle 20. The terms “internal” and “external” qualifying the fin and the reinforcement respectively, are defined in reference to the distance separating the fin and the reinforcement from a median plane of the vehicle, orthogonal to the Y-axis of the direct orthonormal reference, the internal fin being closer to this median plane than the external reinforcement. The assembly 12 according to the disclosure, also comprises a rear support member 8 for a lifting jack fixed by welding onto the securing surface 7 of the assembly device 1. The support member 8 is oriented according to a plane substantially orthogonal to the X-axis of the direct orthonormal reference and in a slightly advanced position (according to the X-axis of the direct orthonormal reference) relative to a median plane of the first section 42 forming the free end of the said transverse groove 6. Due to this slightly advanced position of the support member 8, anchoring element 4 of the rear axle 18 can be brought closer to this median plane, so that the compact footprint, notably the compact footprint according to the X-axis of the direct orthonormal reference, of the assembly 12 according to the disclosure is optimized. The internal fin 11 and the external reinforcement 9 of the anchoring element 4 are welded to the support member 8, the internal fin 11 being also welded with the side member 2 and with the assembly device 1. The support member 8 is also welded to the gusset 10. This results in an optimized compact footprint of the assembly 12 and rigidity of the assembly 12 allowing the installation of the electric batteries 24, as represented in FIG. 5.

As represented in FIG. 4, the assembly device 1 according to the disclosure comprises a first terminal end section 42 able to form the said transverse groove and presenting a front extension 30 fixed by spot welding to a front edge 40 of the cross member 3 and a rear extension 39 fixed by spot welding to a rear edge 41 of the cross member 3. The assembly device 1 according to the disclosure comprises a second flared section 43 from the first section 42 to the said longitudinal clearance 5 and presenting a front extension 44 fixed by spot welding to an edge 46 of the side member 2 and a rear extension 45 fixed by spot welding to the edge 46 of the side member 2.

A general view of an assembly 12 of an electric vehicle 20 according to the disclosure is represented in a flat view from below in FIG. 5. The electric battery elements 24 of the electric vehicle 20 are arranged on a floor in front of the left assembly 12 of the vehicle and the right assembly 48 of the vehicle 20. The assembly 48 is symmetrical to the assembly 12 relative to the median plane of the vehicle 20 and its constituent elements are not detailed again but take up the functionalities, properties, and advantages provided by the assembly 12.

What is claimed is:

1. An assembly device of a side member and a chassis cross member of a motor vehicle, said assembly device being formed of a single rigid metal piece, wherein the assembly device is configured to present an assembly surface portion in contact with each other, by welding, of the assembly device and an anchoring element of a rear axle of the motor vehicle to a chassis of the motor vehicle.

2. The assembly device according to claim 1, wherein the assembly device forms a longitudinal clearance, configured to receive said side member, configured to cooperate by shape cooperation with said side member and configured to secure the assembly device with said side member by welding the assembly device and said side member to each other.

3. The assembly device according to claim 1, wherein the assembly device forms a transverse groove, configured to receive the chassis cross member, configured to cooperate in shape cooperation with the chassis cross member and configured to secure the assembly device to the chassis cross member by welding the assembly device and the chassis cross member to each other.

4. The assembly device according to claim 1, wherein the assembly device is configured to present a secure surface by welding of the assembly device to a rear support member for a vehicle lifting jack.

5. The assembly device according to claim 4, wherein the anchoring element comprises an internal fin assembled by welding to the assembly device and an external reinforcement, the internal fin and the external reinforcement of the anchoring element configured to receive and maintain an end bearing of a suspension arm of the rear axle of the motor vehicle to the chassis of the motor vehicle, the rear support member and the external reinforcement being securely mounted to each other by welding.

6. The assembly device according to claim 4, wherein the rear support member is securely mounted by welding to at least one of a gusset or a spar of the motor vehicle.

7. An assembly comprising the assembly device according to claim 1, further comprising:
an anchoring element of the rear axle of the motor vehicle to the chassis of the motor vehicle, the anchoring element securely mounted with the assembly device by welding; and
a rear support member for a motor vehicle lifting jack, the rear support member securely mounted to the assembly device by welding.

8. A motor vehicle comprising at least one assembly device according to claim 1.

9. The motor vehicle according to claim 8, wherein the motor vehicle is an electric or hybrid vehicle.

10. The motor vehicle according to claim 8, wherein the motor vehicle is an electric vehicle equipped with electric batteries or a fuel cell and at least one hydrogen tank.

11. The motor vehicle according to claim 8, wherein that the motor vehicle is a utility vehicle.
